(19) United States
(12) Patent Application Publication
(10) Pub. No.: US 2003/0112367 A1
(43) Pub. Date: Jun. 19, 2003

(54) Digital broadcast signal reception set-top box facilitating resolution settings for a digital broadcast signal

(75) Inventors: Min-Gu Kang, Seoul (KR); Young-Soo Do, Yongin-City (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/302,827

(22) Filed: Nov. 25, 2002

(30) Foreign Application Priority Data
Dec. 13, 2001 (KR) 2001-79047

(51) Int. Cl. H04N 7/01; H04N 11/20

(52) U.S. Cl. 348/441; 348/445; 348/446; 348/448

(57) ABSTRACT

Disclosed is a digital broadcast signal reception set-top box facilitating resolution settings for a digital broadcast signal. The set-top box has a receiver for receiving a digital broadcast signal, a resolution converter for converting the digital broadcast signal to a signal having a predetermined resolution value, an output part for outputting to an external display device the digital broadcast signal having the resolution value converted by the resolution converter, and a controller for controlling the resolution converter and the output part to sequentially output at predetermined time intervals the digital broadcast signal having the different resolution values and to output, in case that a selection command is inputted for the resolution value from external, the digital broadcast signal converted to a resolution value corresponding to the selection command. The set-top box controls the resolution converter to have any one of plural standard values for the resolution values able to be set by the resolution converter. At this time, the standard values are 480i, 480p, 720p, and 1080i.

### BACKGROUND OF THE INVENTION

1. Field of the Invention

The present invention relates to a digital broadcast reception set-top box, and more particularly to a digital broadcast reception set-top box for converting a received digital broadcast signal to plural resolutions and outputting a digital broadcast signal of a converted resolution to an external display device. The present application is based on Korean Patent Application No. 2001-79047, filed Dec. 13, 2001, which is incorporated herein by reference.

2. Description of the Related Art

In general, a set-top box (STB) is a converter for receiving a digital broadcast signal transferred through wire and/or wireless transmission channels and converting the received digital broadcast signal to a signal of a format displayable on a screen through a display device such as a television set.

FIG. 1 is a view for schematically showing a digital broadcast reception system for listening to digital broadcasts. As shown in FIG. 1, a digital broadcast reception system has a set-top box 3 for restoring a digital broadcast signal received through an antenna 1, and a television receiver 5 for displaying on the screen thereof the digital broadcast signal outputted from the set-top box 3 depending upon a set resolution. At this time, the television receiver 5 displays the digital broadcast signal through a display mode having a different resolution based on a scanning mode.

The set-top box 3 converts the received digital broadcast signal to a format displayable by the television receiver 5. Further, the set-top box 3 converts the digital broadcast signal to a resolution corresponding to a resolution value set in the television receiver 5 connected thereto.

FIG. 2 is a view for showing connection ports disposed on the rear of the set-top box 3 of FIG. 1. As shown in FIG. 2, the set-top box 3 is provided with ports from which an audio signal and various video signals can be outputted. In the meantime, the set-top box 3 is equipped with a resolution conversion switch 3a for converting a resolution of an outputted digital broadcast signal. This converts a digital broadcast signal into a resolution value corresponding to a set resolution value, based on a scanning mode of the television receiver 5 connected to the set-top box 3, so that the converted signal may be output.

In order for a user to view a received digital broadcast signal, the user sets a resolution for the television receiver 5, and switches the resolution conversion switch 3a of the set-top box 3 to a resolution value corresponding to the resolution set to the television receiver 5. At this time, resolution values convertible through the resolution conversion switch 3a have resolution values (1080i, 720p, and 480p) applicable for a digital television receiver and a resolution value (480i) applicable for an analog television receiver. As such, a digital television receiver can be set to be displayed in resolutions of 1080i, 720p, 480p, and 480i for a digital broadcast signal.

However, a user unfamiliar with the use of a digital television receiver may find it troublesome to set the resolution. Moreover, in case that a user does not perceive the interlace scanning and the progressive scanning which are the scanning modes, there are occasions that a user is not aware of the necessity to set the resolution. Further, it is inconvenient to have to manipulate the resolution conversion switch 3a to set the output resolution of the set-top box 3 to the resolution of the television receiver 5.

Accordingly, if a user watches a digital broadcast without matching the resolution of the television receiver 5 with the resolution of the set-top box 3, the user may mistakenly believe that a product is defective since a digital broadcast signal is not clearly displayed on the screen of the television receiver 5.

### SUMMARY OF THE INVENTION

In order to solve the problem, it is an object of the present invention to provide a set-top box which enables the resolution of a digital broadcast signal output by the set-top box to more conveniently match the resolution of a television receiver and a digital broadcast signal resolution setting method using the same.

In order to achieve the above object, a set-top box comprises a receiver for receiving a digital broadcast signal, a resolution converter for converting the digital broadcast signal to a signal having a predetermined resolution value, an output part for outputting to an external display device the digital broadcast signal having the resolution value converted by the resolution converter, and a controller for controlling the resolution converter and the output part to sequentially output at predetermined time intervals the digital broadcast signal having different resolution values and to output, in case that a selection command is externally inputted for the resolution value, the digital broadcast signal converted to a resolution value corresponding to the selection command.

Preferably, the set-top box further comprises a storage part for storing plural standard values for the resolution values able to be set by the resolution converter. Accordingly, the controller controls the resolution converter in order for the digital broadcast signal to have any one of the standard values. At this time, it is preferable that the standard values stored in the storage part are 480i, 480p, 720p, and 1080i.

Further, the set-top box comprises an On Screen Display (OSD) part for generating an OSD screen providing either information on the resolution value of the digital broadcast signal outputted from the output part or information for a selection of a user as to whether to display the digital broadcast signal at the resolution value. Accordingly, the controller controls the output part in order for the information generated from the OSD part to be outputted together with the digital broadcast signal. In the meantime, the set-top box comprises an input part for inputting a selection command to the controller for a resolution to be outputted.

In the meantime, the object is achieved by a digital broadcast signal resolution setting method using a set-top box according to the present invention which comprises steps of: a) receiving a digital broadcast signal, b) outputting sequentially to an external display device the digital broadcast signal having different resolution values at predetermined time intervals, c) receiving a selection command for a resolution value of the digital broadcast signal resolution value, d) converting a digital broadcast signal resolution to a resolution value corresponding to the selection command based on the reception of the selection command, and e) outputting to the external display device the digital broadcast signal having the resolution value corresponding to the selection command.

Preferably, in the step b), the resolution value is any one of plural standard values. At this time, the standard values are at least any one of 480i, 480p, 720p, and 1080i. Moreover, before the step c), a step is preferably included for generating an On Screen Display (OSD) display providing at least either information on the resolution values of the outputted digital broadcast signal or information for a selection of a user as to whether to display the digital broadcast signal at the resolution value. By doing so, at the output stage, a digital broadcast signal is outputted together with information on a resolution value and information on a selection of an output resolution value.

According to the present invention, the operations of the resolution converter is controlled to sequentially convert a digital broadcast signal to different resolution values for an output at predetermined time intervals, and, in case that any one of outputted resolution values is selected for an output, the digital broadcast signal resolution is converted to the selected resolution value for the output, enabling the resolution settings of the set-top box and a display device to be carried out with ease.

### BRIEF DESCRIPTION OF THE DRAWINGS

The above objects and other features of the present invention will become more apparent by describing in detail a preferred embodiment thereof with reference to the attached drawings, in which:

FIG. 1 is a view for schematically showing a digital broadcast reception system using a set-top box;

FIG. 2 is a view for showing connection ports disposed in the rear of the set-top box of FIG. 1;

FIG. 3 is a block diagram for showing a set-top box according to a preferred embodiment of the present invention;

FIG. 4 is a table for showing standard values for resolution conversions stored in a storage part of FIG. 3;

FIG. 5 is an exemplary block diagram for showing in detail an output port of an output part of FIG. 3;

FIG. 6 is a flow chart for showing a method for controlling a digital broadcast signal output according to a preferred embodiment of the present invention; and

FIG. 7 is a flow chart for showing in detail a resolution conversion and output step, a selection command reception step, and a resolution conversion and output step corresponding to a selection command of FIG. 6 according to a preferred embodiment of the present invention.

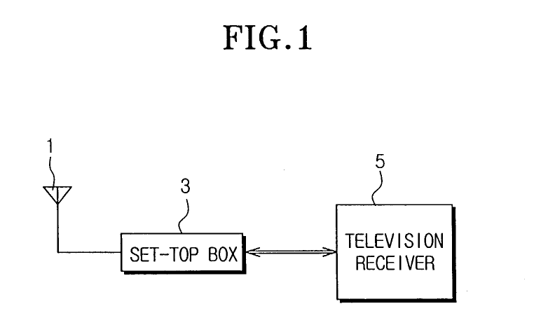

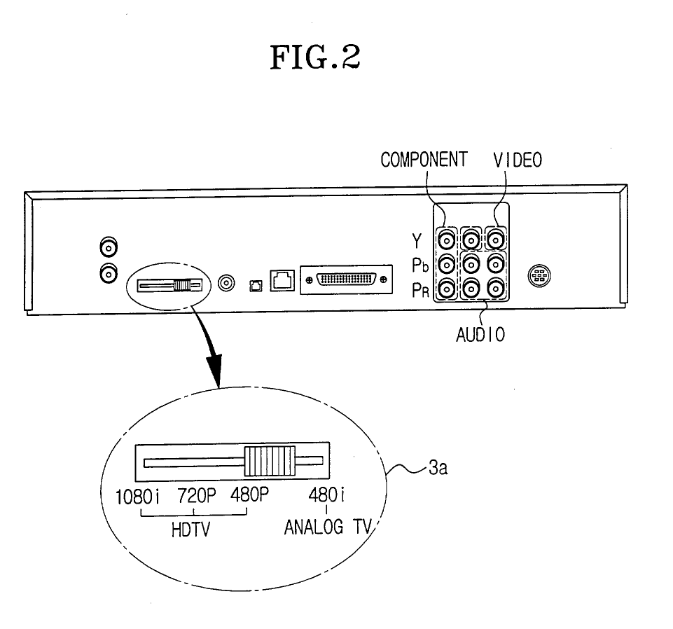

### DETAILED DESCRIPTION OF THE PREFERRED EMBODIMENT

Hereinafter, the present invention will be described in detail with reference to the accompanying drawings.

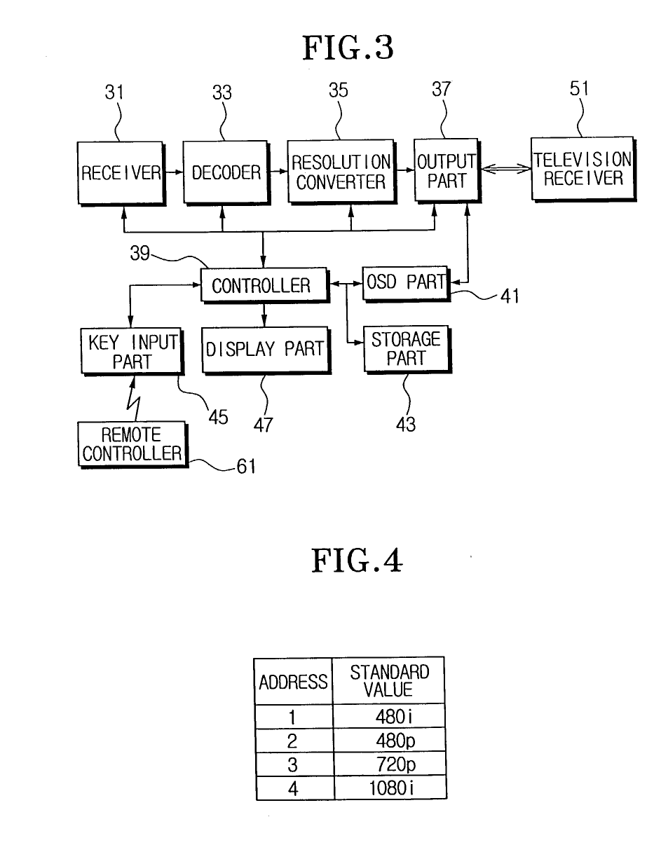

FIG. 3 is a block diagram for showing a set-top box facilitating resolution settings according to a preferred embodiment of the present invention. As shown in FIG. 3, the set-top box has a receiver 31 for receiving a digital broadcast signal, a decoder 33 for decoding the received digital broadcast signal, a resolution converter 35 for converting a resolution of a digital broadcast signal outputted from the decoder 33, an output part 37 connected to an external display device and for outputting a digital broadcast signal outputted from the resolution converter 35, and a controller 39 for controlling operations of the receiver 31, decoder 33, resolution converter 35, and output part 37. At this time, a television receiver 51 is connected as the external display device connected to the output part 37.

The receiver 31 receives a digital broadcast signal transferred through a transmission channel of a wireless transmission channel or a wire transmission channel. The resolution converter 35 converts a digital broadcast signal outputted from the decoder 33 into a signal having a predetermined resolution value. At this time, the resolution converter 35 can convert a digital broadcast signal into plural resolution values. Preferably, the resolution converter 35 converts, if initial resolution converting operations are performed, a digital broadcast signal into different resolution values at predetermined time intervals. Accordingly, the controller 39 controls the operations of the resolution converter 35 to sequentially convert, if a resolution conversion command is externally input, a digital broadcast signal into different resolution values at predetermined time intervals and to convert a digital broadcast signal resolution into a resolution value corresponding to an externally input selection command.

In the meantime, the television receiver 51 correctly displays on its screen a digital broadcast signal, out of digital broadcast signals outputted from the output part 37, converted into the same resolution value as that of the television receiver 51. However, if a digital broadcast signal outputted from the output part 37 is a digital broadcast signal converted into a resolution value different from the resolution value of the television receiver 51, the digital broadcast signal is not correctly displayed on the screen of the television receiver 51.

The set-top box has a storage part 43 for storing plural standard values for the resolution values into which the resolution converter 35 converts. Accordingly, the controller 39 controls the operations of the resolution converter 35 in order for a digital broadcast signal to have any one of the standard values stored in the storage part 43. At this time, the standard values stored in the storage part 43 are 480i, 480p, 720p, and 1080i. Preferably, as shown in FIG. 4, the standard values of 480i, 480p, 720p, and 1080i are tabulated and table addresses corresponding to the respective standard values are designated, so the storage part 43 sends to the controller 39 a standard value corresponding to a designated table address if the controller 39 designates a table address. When the controller 39 provides a standard value to the resolution converter 35, 480i, 480p, 720p, and 1080i are sequentially provided at certain time intervals to the resolution converter 35.

Further, the set-top box has an OSD part 41 generating an OSD screen containing information on a resolution value of a digital broadcast signal outputted from the output part 37 and information for letting a user make a selection of whether a digital broadcast signal is displayed at a converted resolution value. Accordingly, the controller 39 controls the output operations of the output part 37 in order for the information outputted from the OSD part 41 to be outputted together with the digital broadcast signal.

Further, the set-top box has an input part 45 for inputting a resolution conversion operation command as to a digital broadcast signal. At this time, the input part 45 receives a control signal outputted from a remote controller 61, and provides the controller 39 with the received control signal, to thereby enable the controller 39 to carry out operations corresponding to the control signal. Preferably, the set-top box of the present embodiment has a display part 47 for displaying an operation state of the set-top box. The display part 47 may indicate resolution information on a digital broadcast signal which is outputted through the output part 37 at a resolution converted in the resolution converter 35 based on a control command of the controller 39.

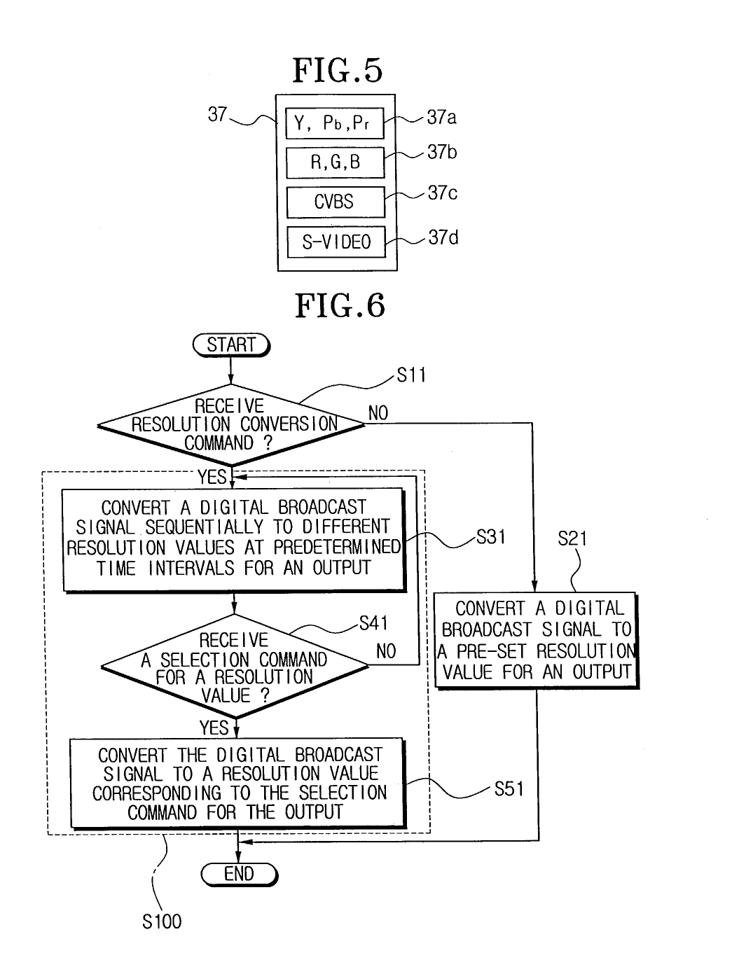

FIG. 5 is a block diagram for showing in detail output ports of the output part 37 of FIG. 3. The output part 37 of FIG. 5 has a Y/Pb/Pr port 37a, an RGB port 37b, a CVBS port 37c, and an S-Video port 37d. The Y/Pb/Pr port 37a, RGB port 37b, CVBS port 37c, and S-Video port 37d can be coupled to a digital television receiver, and the CVBS port 37c and S-Video port 37d may be coupled to an analog television receiver. Accordingly, a digital broadcast signal having a resolution value of 480i, 480p, 720p, or 1080i can be outputted at the Y/Pb/Pr port 37a and the RGB port 37b, and 480i or 480p at the CVBS port 37c and the S-Video port 37d.

With the present embodiment, if a resolution conversion operation command is inputted to the controller 39 through the input part 45 and the remote controller 61 when a digital television receiver is coupled to the Y/Pb/Pr port 37a, the controller 39 takes a resolution standard value out of the storage part 43 and controls the operations of the resolution converter 35 to convert, for an output, a resolution of a digital broadcast signal to be outputted based on the taken standard value. At this time, a user can determine whether the resolution value of the digital broadcast signal outputted through the output part 37 matches a resolution value of the television receiver 51, viewing a screen state displayed on the screen of the television receiver 51.

Accordingly, a user can determine a resolution value of a digital broadcast signal to be converted in the resolution converter 35 and outputted through the output part 37 based on resolution information and selection command information displayed in an OSD state on the screen of the television receiver 51. If a resolution value to be outputted is selected by a user, the controller 39 controls the operations of the resolution converter 35 and the output part 37 in order that a digital broadcast signal is converted to the selected resolution value and the converted digital broadcast signal is outputted through the output part 37.

FIG. 6 is a flow chart for showing a method for controlling an output of a digital broadcast signal according to a preferred embodiment of the present invention. First, the controller 39 determines whether a resolution conversion command is received through the input part 45 and the remote controller 61 (S11). If it is determined that the resolution conversion command is not received, the controller 39 controls the operations of the resolution converter 35 and the output part 37 to convert a digital broadcast signal to a pre-set resolution value for an output (S21).

If it is determined that the resolution conversion command is received in step S11, the controller 39 controls the operations of the resolution converter 35 and the output part 37 to sequentially convert a digital broadcast signal to a different resolution value at a predetermined time interval for an output based on the received resolution conversion command (S31). Then, the controller 39 determines whether a resolution value selection command is received from a user while the resolution value-converted digital broadcast signal is displayed on the screen of the television receiver 51 (S41).

At this time, if it is determined that the selection command is not received for the outputted resolution value after a predetermined time has lapsed, the controller 39 carries out the operations of the steps S31 and S41. If it is determined that the selection command is received in step S41, the controller 39 controls the operations of the resolution converter 35 and the output part 37 to convert a digital broadcast signal resolution to a resolution corresponding to the received selection command and to output a digital broadcast signal of the converted resolution to the television receiver 51 (S51).

In the step S31, the controller 39 controls the operations of the resolution converter 35 to convert a digital broadcast signal resolution to any one of the standard values stored in the storage part 43 with respect to the resolution values convertible for a digital broadcast signal. Further, when outputting a digital broadcast signal to the television receiver 51 in the step S31, the controller 39 includes, for an output, information on a resolution value of an outputted digital broadcast signal through the OSD part, and information on a user's selection as to whether a digital broadcast signal is converted to the displayed resolution value for an output.

Accordingly, a user can control the resolution conversion and output operations of a set-top box through display states indicated on the screen of the television receiver 51.

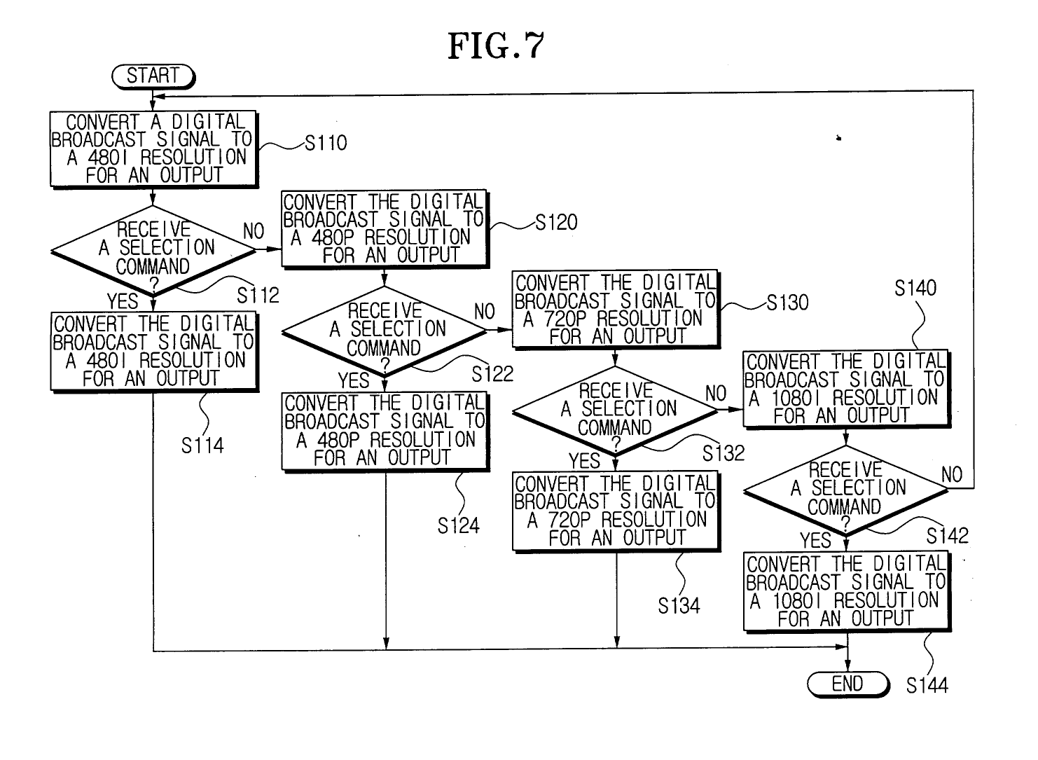

FIG. 7 is a flow chart for showing in detail an output resolution setting step S100 including the resolution conversion and output step S31, the selection command reception step S41, and the resolution conversion and output step S51 corresponding to the selection command in FIG. 6 according to a preferred embodiment of the present invention.

First, the controller 39 controls the resolution converter 35 and the output part 37 to convert a digital broadcast signal to a 480i resolution for an output (S110). After a predetermined time lapse, the controller 39 determines whether a selection command is received to convert the digital broadcast signal to the 480i resolution (S112). If it is determined that the selection command is received, the controller 39 controls the operations of the resolution converter 35 and the output part 37 to convert the digital broadcast signal to the 480i resolution for the output (S14).

If it is determined that the selection command is not received in the step S112, the controller 39 controls the operations of the resolution converter 35 and the output part 37 to convert the digital broadcast signal to a 480p resolution for the output (S120). After a predetermined time lapse, the controller 39 determines whether a selection command is received to convert the digital broadcast signal to the 480p resolution (S122). If it is determined that the selection command is received, the controller 39 controls the operations of the resolution converter 35 and the output part 37 to convert the digital broadcast signal to the 480p resolution for the output (S124).

If it is determined that the selection command is not received in the step S122, the controller 39 controls the operations of the resolution converter 35 and the output part 37 to convert the digital broadcast signal to a 720p resolution for the output (S130). After a predetermined time lapse, the controller 39 determines whether a selection command is received to convert the digital broadcast signal converted to the 720p resolution (S132). If it is determined that the selection command is received, the controller 39 controls the operations of the resolution converter 35 and the output part 37 to convert the digital broadcast signal to the 720p resolution for the output (S134).

If it is determined that the selection command is not received in the step S132, the controller 39 controls the operations of the resolution converter 35 and the output part 37 to convert the digital broadcast signal to a 1080i resolution for the output (S140). After a predetermined time lapse, the controller 39 determines whether the selection command is received for converting the digital broadcast signal converted to the 1080i resolution (S142). If it is determined that the selection command is received, the controller 39 controls the operations of the resolution converter 35 and the output part 37 to convert the digital broadcast signal to the 1080i resolution for the output (S144).

If it is determined that the selection command is not received in the step S142, the operations of the steps S110 to S140 are carried out.

Accordingly, setting an output of a digital broadcast signal converted to a resolution corresponding to a resolution value of a television receiver through the set-top box is facilitated.

According to the present invention, the operation of the resolution converter is controlled to sequentially convert a digital broadcast signal to different resolution values for an output at predetermined time intervals, and, in case that any one of outputted the resolution values is selected for the output, the digital broadcast signal resolution is converted to the selected resolution value for the output, so the resolution setting of the set-top box and a display device can be carried out with ease.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A set-top box, comprising:
a reception means for receiving a digital broadcast signal;
a resolution conversion means for converting the digital broadcast signal to a signal having a resolution value selected from a plurality of predetermined resolution values;
an output means for outputting to an external display device the digital broadcast signal having the resolution value converted by the resolution conversion means; and
a control means for controlling the resolution conversion means and the output means to sequentially output at predetermined time intervals the digital broadcast signal having different resolution values of the plurality of predetermined resolution values, and to output, in case that a selection command is externally input, the digital broadcast signal converted to a resolution value corresponding to the selection command.

2. The set-top box as claimed in claim 1, further comprising a storage means for storing plural standard values corresponding to the plurality of predetermined resolution values, the control means controlling the resolution conversion means in order for the digital broadcast signal to have any one of the standard values.

3. The set-top box as claimed in claim 2, wherein the standard values are at least one of 480i, 480p, 720p, and 1080i.

4. The set-top box as claimed in claim 3, wherein the reception means receives the digital broadcast signal transferred through at least one of a wireless transmission channel and a wire transmission channel.

5. The set-top box as claimed in claim 3, further comprising an On Screen Display(OSD) means for generating an OSD screen providing at least either information on the resolution value of the digital broadcast signal outputted from the output means or information for a selection of a user as to whether to display the digital broadcast signal at the resolution value, the controller controlling an output part in order for the information generated from the OSD means to be outputted together with the digital broadcast signal.

6. The set-top box as claimed in claim 5, further comprising an input means for inputting a selection command to the control means.

7. A digital broadcast signal resolution setting method using a settop box, comprising steps of:
a) receiving a digital broadcast signal;
b) outputting sequentially to an external display device the digital broadcast signal having different resolution values at predetermined time intervals;
c) receiving a selection command for a digital broadcast signal resolution value;
d) converting a digital broadcast signal resolution to a resolution value corresponding to the selection command based on the reception of the selection command; and
e) outputting to the external display device the digital broadcast signal having the resolution value corresponding to the selection command.

8. The method as claimed in claim 7, wherein, in the step b), the resolution value is any one of plural standard values.

9. The method as claimed in claim 8, wherein the standard values are at least one of 480i, 480p, 720p, and 1080i.

10. The method as claimed in claim 9, wherein, before the step c), a step is included for generating an On Screen Display (OSD) display providing at least either information on the resolution values of the outputted digital broadcast signal or information for a selection of a user as to whether to display the digital broadcast signal at the resolution value.
